(19) United States
(12) Patent Application Publication
(10) Pub. No.: US 2023/0021217 A1
(43) Pub. Date: Jan. 19, 2023

(54) PERMANENT CONNECTOR

(71) Applicant: GRIPPS GLOBAL PTY LTD AS TRUSTEES FOR DTR GROUP, TULLAMARINE (AU)

(72) Inventor: Richard John Salisbury, Plenty (AU)

(21) Appl. No.: 17/866,140

(22) Filed: Jul. 15, 2022

Related U.S. Application Data
(60) Provisional application No. 63/222,389, filed on Jul. 15, 2021.
(60) Provisional application No. 63/252,597, filed on Oct. 5, 2021.

(51) Int. Cl. F16L 21/08

(52) U.S. Cl. CPC F16L 21/08

(57) ABSTRACT

A permanent connector for making a connection point or for connecting objects together. The connector has a body with first and second ends. A male end is connected to the first end and has a neck portion with a groove. The groove has a base and straight sidewalls extending generally perpendicular to the base. A female end is connected to the second end and has an opening defined by interior walls. A recess is formed in the interior walls with a snap ring mounted in the recess. The snap ring is received within the groove when the male end is inserted into the female end resulting in the male end being permanently connected within the female end.

### CROSS-REFERENCE TO RELATED APPLICATION

This application claims the benefit of U.S. Provisional Application No. 63/222,389 filed on Jul. 15, 2021, which is incorporated hereby by reference in its entirety.

### STATEMENT REGARDING FEDERALLY SPONSORED RESEARCH

NONE.

### TECHNICAL FIELD

This invention relates generally to connectors and more particularly to connectors used to tether tools

### BACKGROUND OF THE INVENTION

Tools and objects from dropped from elevated environments consistently play a leading role, as one of the highest causes of fatalities and serious injuries for workers on-site. To combat this danger, there are numerous tool tethering products to tether tools to the worker. In many applications, the tether is attached directly to the tool. Examples of such tethers are tool hitches and tool catches with tape to apply to the tool. In other applications, there is a connection point created through an opening in the tool. Examples of these applications are swivel catches and screw lock cables.

What is needed is a connection point that is easily created and permanent. A permanent connection point that can be created by plug and lock.

### SUMMARY OF THE INVENTION

A permanent connector is provided for making a connection point or for connecting objects together. The connector has a body with first and second ends. A male end is connected to the first end and has a neck portion with a groove. The groove has a base and straight sidewalls extending generally perpendicular to the base. A female end is connected to the second end and has an opening defined by interior walls. A recess is formed in the interior walls with a snap ring mounted in the recess. The snap ring is received within the groove on the neck when the male end is inserted into the female end resulting in the male end being permanently connected within the female end.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a perspective view of the permanent connector of the present invention in the open position.

FIG. 2 is a perspective view of the present invention in the closed position creating a connection point on a tool.

FIG. 3 is a perspective view of the male end of the present invention.

FIG. 4 is a further perspective view of the male end of the present invention.

FIG. 5 is a perspective view of the female end of the present invention.

### DETAILED DESCRIPTION OF A PREFERRED EMBODIMENT

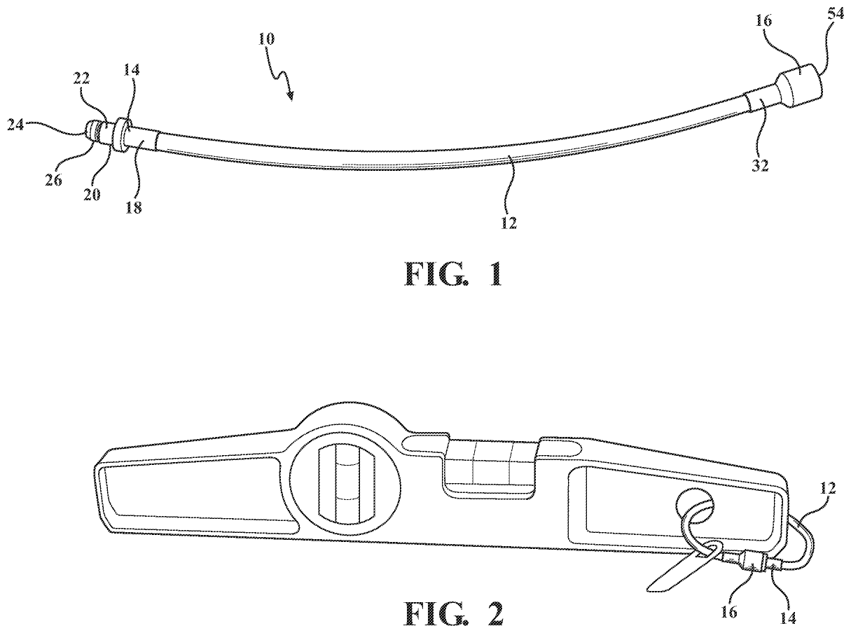

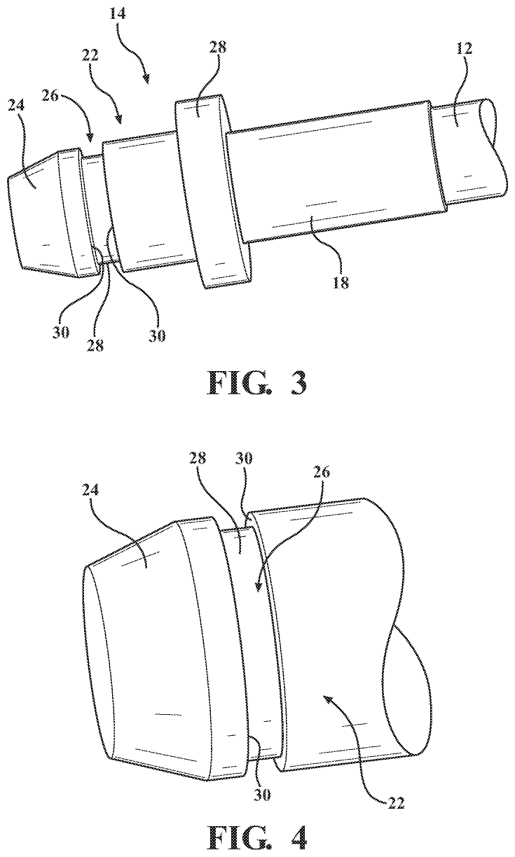

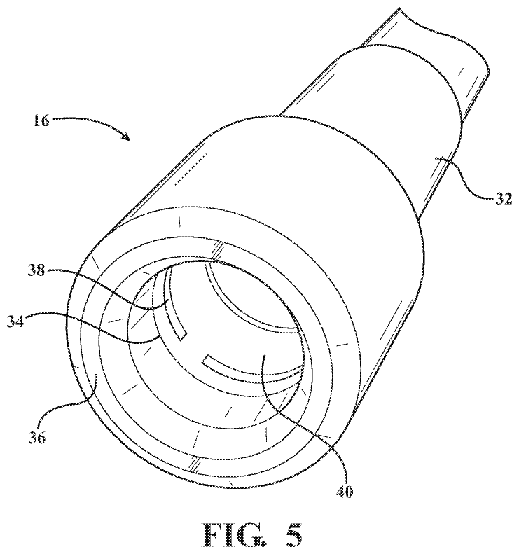

The permanent connector of the present invention is shown generally at 10 in the figures. FIG. 1 illustrates the connector 10 in the open position and FIG. 2 illustrates connector 10 in the permanently closed position. Connector 10 can be used to create a permanent connection point on an object, such as a tool, tether, belt, harness, or for connecting two objects together. The connection is made by plug and lock. The connector 10 is particularly useful when working in elevated environments to prevent inadvertent dropping of tools. The connector 10 of the present invention doesn't disconnect once connected so that a positive, secure, and permanent connection is achieved.

Connector 10 has a core band or body 12 with a male end 14 and an opposed female end 16. In the disclosed embodiment, the body 12 is a cable made of strands of aircraft grade steel covered with plastic and the ends 14 and 16 are made of brass. However, one of ordinary skill in the art will understand that body 12 doesn't have to be a cable, and that other materials could be used for the body 12 and ends 14 and 16, including, steel, aluminum, or plastic for example. With reference to FIG. 2, the connector 10 can be inserted into an opening on a tool 11 for example to create a connection point. The connection point is created by plugging or inserting the end 14 into the end 16 to permanently lock the two together. It is a quick, easy, and secure connection point.

The male end 14 has a mounting portion 18 for mounting to the body 12. A raised collar 20 separates the mounting portion 18 from a neck portion 22. The neck portion 22 is adapted to be inserted into the female end 16. The collar 20 forms a grip section to facilitate insertion. The neck portion 22 ends in a truncated cone 24. A groove 26 is formed in the neck portion adjacent to the cone 24. The groove 26 has a base or bottom 28 and opposed straight walls 30. The walls 30 are at a generally right angle to the base 28.

The female end 16 has a mounting portion 32 to mount the female end 16 to the body 12. The female end 16 has an opening 34 defined by interior walls for receipt of the neck 22. The opening 34 has an entrance with an angled surface 34 that facilitates the receipt of the truncated cone 24 on neck portion 22. Spaced from the entrance 36 is a recess 38. A snap ring 40 is mounted within the recess 38. The snap ring 40 can be expanded by the truncated cone 24 on the male end 14.

When the neck 22 is inserted into the female end 16, the snap ring 40 is expanded by the cone 24 and then slides along the neck 22 until it snaps into the groove 26. Because of the straight walls 30 of the groove 26, the male end 14 is locked within the female end 16. The snap ring 40 can't be expanded and cannot escape the groove 26. Therefore, the male end 14 is permanently locked within the female and 16.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A connector comprising:
a body having first and second ends;
a male end connected to said first end, said male end having a neck portion; a groove formed in said neck portion, said groove having a base and straight sidewalls extending generally perpendicular to said base;
a female end connected to said second end, said female end having an opening defined by interior walls, a recess formed in said interior walls;
a snap ring mounted in said recess;
said snap ring being received within said groove when said male end is inserted into said female end;
whereby said male end is permanently connected within said female end.

2. The connector of claim 1, wherein said neck ends in a truncated cone.

3. The connector of claim 1, further including a collar to facilitate insertion of said male end into said female end.

4. The connector of claim 1, further including a mounting portion on each of said male and female ends for connecting said male and female ends to said body.

5. The connector of claim 1, wherein said opening has an angled surface.

6. The connector of claim one, wherein said opening has an interior diameter greater than the outer diameter of said neck.

7. The connector of claim 1, wherein said male end and female end are made of metal.

8. The connector of claim 1, wherein said male end and female end or made of brass.

9. The connector of claim 1, wherein that said body portion is a cable.
